(19) United States
(12) Patent Application Publication
(10) Pub. No.: US 2002/0096880 A1
(43) Pub. Date: Jul. 25, 2002

(54) Single-pipe connector piece

(75) Inventors: Britt-Astrid Schulz, Neuss (DE); Franko Seeliger, Emstetten (DE); Wolfgang Bluhm, Essen (DE)

Correspondence Address: THE FIRM OF KARL F ROSS, 5676 RIVERDALE AVENUE, PO BOX 900, RIVERDALE (BRONX), NY, 10471-0900, US

(73) Assignee: VITERRA ENERGY SERVICES AG

(21) Appl. No.: 09/974,740

(22) Filed: Oct. 10, 2001

(30) Foreign Application Priority Data
Oct. 13, 2000 (DE) 20017613.7

(51) Int. Cl. F16L 39/00

(52) U.S. Cl. 285/133.11; 285/423

(57) ABSTRACT

The invention relates to a single-pipe connector piece for the installation of a metering device for a flowing medium in a pipeline, having an inlet-side connector element and an outlet-side connector element and having a connector element for the metering device. In order to provide a single-pipe connector piece that is versatile and, in particular, can be used without any health restrictions, the single-pipe connector piece is to consist, at least in the medium-conducting regions, of non-metallic materials, such as, for example, plastic.

The invention relates to a single-pipe connector piece for the installation of a metering device for a flowing medium in a pipeline, having an inlet-side connector element and an outlet-side connector element and having a connector element for the metering device.

Such single-pipe connector pieces are known in practice that permit easy replacement of the metering device in the event of defects or after the expiry of the calibration certificate without interference with the pipe network, and which customarily consist of brass, gunmetal or similar metal alloys because of the high levels of strength required, in particular as regards the resistance to pressure and as regards connection to the adjoining piping.

A disadvantage here is that traces of individual constituents of these metal alloys may be dissolved out. When brass is used, for example, the constituent in question is the heavy metal lead. This may result in adverse effects on health, above certain concentrations, and such effects cannot be reliably excluded. For this reason, various countries have imposed restrictions on brass components in drinking water systems. Another disadvantage of single-pipe connector pieces made from such metal alloys lies in the risk of stress cracking corrosion, which may be caused by the dissolving-out of baser metal constituents from the metal alloy. As a result, fracture of the single-pipe connector piece may occur, which may lead to consequential damage, such as, for example, water damage to the masonry and require costly repairs, such as, for example, a replacement of components.

It is an object of the invention to avoid the abovementioned disadvantages and to provide a single-pipe connector piece which is versatile and can be used without any particular health restrictions.

This object is achieved by a single-pipe connector piece for the installation of a metering device for a flowing medium in a pipeline, having an inlet-side connector element and an outlet-side connector element and having a connector element for the metering device, the single-pipe connector piece consisting, at least in the medium-conducting regions, of non-metallic materials, such as, for example, plastic. The effect of this is that the possibility of metallic constituents being washed out by the flowing medium is reliably avoided, so that the single-pipe connector piece is not weakened and the flowing medium is not contaminated. Examples of suitable materials that can be used include plastic and ceramic, so that an additional advantage is that production is simpler and more cost-effective.

Preferably, the non-metallic material can be a plastic that is resistant to temperatures up to approximately 90° C., so that the single-pipe connection piece is also useable for heated media, such as, for example, in hot water supply systems, without any occurrence of weakening and/or distortion.

Furthermore, the non-metallic material may be a fibre-reinforced material, resulting in higher material strength and stress resistance. For this purpose, the material may be provided, even before the single-pipe connector piece is manufactured, with fibre-reinforcing constituents, for example plastic granules with glass fibre constituents, and/or fibre inserts may be provided at least in some poritions of the single-pipe connector piece. These may preferably be provided at least in particularly highly stressed regions of the single-pipe connector piece, for example in the region of the connector elements, and may be in the form of peripheral windings.

Advantageously, at least one connector element may comprise a threaded insert made from metal, in particular brass, so that in addition to a guarantee of adequate material strength, even in the absence of reinforcing elements, identical fixing possibilities to those provided by conventional single-pipe connector pieces still exist and it is unnecessary to retool or change the method of assembly for fitters and craftsmen.

For this purpose, at least one connector element may comprise a threaded insert made from rigid plastic.

In a preferred example of embodiment of the invention, the connector element for the metering device may comprise a seal to separate the housing of the metering device from the flowing medium, so that even if the housing metering device, in the form of a cartridge meter, is made from conventional metallic materials such as, for example, brass or the like, the flowing medium does not come into contact with those materials and so cannot be contaminated thereby.

According to the invention, at least one connector element may contain an internal thread or an external thread. In this case, the internal thread may be of conical form and taper somewhat towards the inside, so that when it is screwed to a normal external thread sealing takes place automatically as a result of the tapering of the internal thread. For this purpose, the external thread may also be of conically widening form, and the plug connection may also be conical in design.

Advantageously, at least one thread may be in the form of a plastic thread, in particular a plastic trapezoidal thread, so that not only is the single-pipe connector piece simpler to produce, being made from a single material, but the thread is also correspondingly more resistant.

In addition, at least one connector element may comprise a bayonet connection or suitable securing elements for a bayonet connection, or at least one connector element may be formed as a flanged connection, in particular provided with a securing device against axial displacement, such as, for example, a shackle, a securing screw, a snap ring or the like.

Furthermore, at least one connector element may be formed as a plug connection, in particular provided with a securing device against axial displacement, such as, for example, a shackle, a securing screw, a snap ring or the like, the pipe-side part of the plug connection having an internal shape adapted to the piping.

Preferably, reinforcing ribs may be provided on the outside, so that particularly stressed regions, such as, for example, the connector elements, can be selectively reinforced, in particular as regards the conical internal thread provided there. For this purpose, also, at least one connector element may comprise on the outside a peripheral reinforcing element, in particular in the shape of a regular cylinder.

In a preferred example of embodiment, at least one connector element may be connected to the single-pipe connector piece via means for neutralizing the connecting force, in particular screwing force, in particular a snap ring or the like.

In the text that follows, examples of embodiment of the invention shown in the drawings are explained. In the drawings:

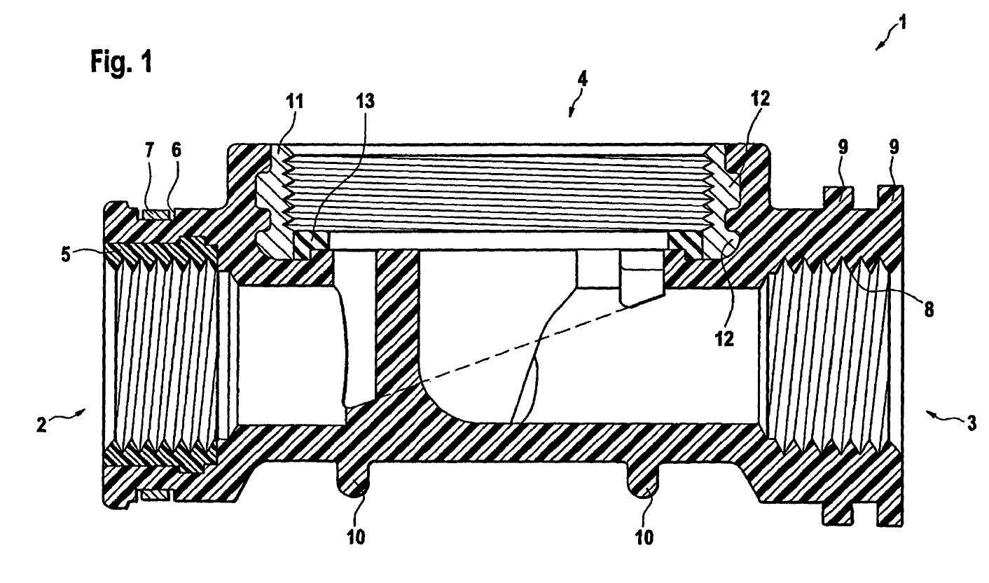

FIG. 1 shows a first embodiment of a single-pipe connector piece and

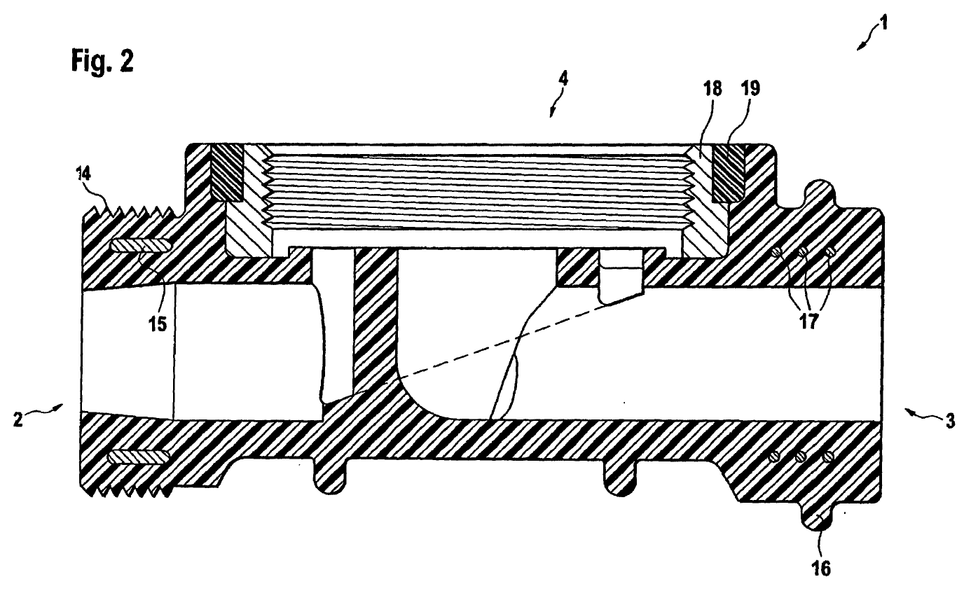

FIG. 2 shows a further example of embodiment.

In all figures, the same reference numerals are used for all similar or identical components.

FIG. 1 shows a single-pipe connector piece 1 for the installation of a metering device (not shown in the drawing) for a flowing medium in piping (likewise not shown in the drawing). The single-pipe connector piece 1 consists of an inlet-side connector element 2 and an outlet-side connector element 3 for connection to the respective parts of the piping. Furthermore, a connector element 4 is provided for the metering device (not shown).

The metering device here may comprise both means for recording and means for displaying the throughput, which means may preferably be integrated into a completely replaceable unit.

The medium here flows through the inlet-side connector element 2, which comprises an annular outlet in the connector element 4 for the metering device, then through the metering device and on via the continuation of the outlet-side connector element 3 disposed coaxially in the annular outlet.

The single-pipe connector piece 1 consists in this case of a plastic material that is resistant to temperatures of up to approximately 90° C. and comprises reinforcing fibre constituents contained within the material. The inlet-side connector element 2 comprises a threaded insert made from metal or rigid plastic having a conical internal thread 5 tapering towards the centre of the single-pipe connector piece 1, so that when it is screwed to an external thread of straight form attached to the piping, a sealing of the connection is automatically caused by the conicity. To avoid splaying of the inlet-side connector element 2 or even damage, for example as a result of the splitting-open of the connector element 2, a reinforcing element 7 of regular cylindrical form is provided in a peripheral exterior recess 6.

The outlet-side connector element 3 comprises an internal thread 8 and external circumferential reinforcing ribs 9.

The underneath region of the single-pipe connector piece 1 is also provided with reinforcing ribs 10.

The connector element 4 for the metering device also comprises a threaded insert 11, which is retained in the connector element 4 by projections 12. Provided on the underside is a seal 13, which separates the housing of the metering device (not shown) from the flowing medium.

FIG. 2 shows a further example of embodiment of a single-pipe connector piece 1 according to the invention, in which the inlet-side connector element 2 comprises an external thread 14 and a peripheral reinforcing element 15 of cylindrical form located in the material. The outlet-side connector element 3 has an externally circumferential bead-like ring 16 and reinforcing fibre inserts 17 embedded in the material, so that when a plug connection is formed the corresponding forces are absorbed.

The connector element 4 for the metering device comprises a threaded insert 18 provided with an internal thread, which is fixed by a plastic ring 19 welded in ultrasonically.

1. Single-pipe connector piece (1) for the installation of a metering device for a flowing medium in a pipeline, having an inlet-side connector element (2) and an outlet-side connector element (3) and having a connector element (4) for the metering device, characterized in that the single-pipe connector piece (1) consists, at least in the medium-conducting regions, of non-metallic materials such as, for example, plastic.

2. Single-pipe connector piece (1) according to claim 1, characterized in that the non-metallic material is a plastic that is resistant to temperatures up to approximately 90° C.

3. Single-pipe connector piece (1) according to claim 1 or 2, characterized in that the non-metallic material is a fibre-reinforced material.

4. Single-pipe connector piece (1) according to claim 3, characterized in that fibre inserts (17) are provided, at least in some portions.

5. Single-pipe connector piece (1) according to one of claims 1 to 4, characterized in that at least one connector element (2, 3, 4) comprises a threaded insert (11) made from metal, in particular brass.

6. Single-pipe connector piece (1) according to one of claims 1 to 5, characterized in that at least one connector element (2, 3, 4) comprises a threaded insert (18) made from rigid plastic.

7. Single-pipe connector piece (1) according to one of claims 1 to 6, characterized in that the connector element (4) for the metering device, which is in the form of a cartridge meter, comprises a seal (13) for separating the housing, in particular the brass sleeve of the metering device, from the flowing medium.

8. Single-pipe connector piece (1) according to one of claims 1 to 7, characterized in that at least one connector element (2, 3, 4) comprises an internal thread (8).

9. Single-pipe connector piece (1) according to one of claims 1 to 8, characterized in that at least one connector element (2, 3, 4) comprises an external thread (14), especially of conical shape.

10. Single-pipe connector piece (1) according to claim 8 or 9, characterized in that at least one thread (8, 14) is formed as a plastic thread, in particular a plastic trapezoidal thread.

11. Single-pipe connector piece (1) according to one of claims 1 to 10, characterized in that at least one connector element (2, 3, 4) comprises a bayonet connection or suitable securing elements for a bayonet connection.

12. Single-pipe connector piece (1) according to one of claims 1 to 11, characterized in that at least one connector element (2, 3, 4) is formed as a flanged connection, in particular provided with a securing device against axial displacement, such as, for example, a shackle, a securing screw, a snap ring or the like.

13. Single-pipe connector piece (1) according to one of claims 1 to 12, characterized in that at least one connector element (2, 3, 4) is formed as a plug connection, in particular provided with a securing device against axial displacement, such as, for example, a shackle, a securing screw, a snap ring or the like.

14. Single-pipe connector piece (1) according to one of claims 1 to 13, characterized in that the pipe-side part of the plug connection has an internal shape adapted to the piping.

15. Single-pipe connector piece (1) according to one of claims 1 to 14, characterized in that reinforcing ribs (10) are provided on the outside.

16. Single-pipe connector piece (1) according to one of claims 1 to 15, characterized in that at least one connector element (2, 3, 4) comprises on the outside a peripheral reinforcing element, in particular in the shape of a regular cylinder.

17. Single-pipe connector piece (1) according to one of claims 1 to 16, characterized in that at least one connector element is connected to the single-pipe connector piece via means for neutralizing the connecting force, in particular screwing force, in particular a snap ring or the like.
